(19) United States
(12) Patent Application Publication
(10) Pub. No.: US 2010/0272150 A1
(43) Pub. Date: Oct. 28, 2010

(54) RECEIVING APPARATUS AND RECEIVING METHOD OF IMPULSE-RADIO UWB WIRELESS SYSTEM

(76) Inventors: Min Su Kil, Chungcheongnam-do (KR); Jae Young Kim, Daejeon (KR); Joo Ho Park, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/747,007

(22) PCT Filed: Jul. 11, 2008
(86) PCT No.: PCT/KR08/04109

§ 371 Date: Jun. 9, 2010

(30) Foreign Application Priority Data
Dec. 10, 2007 (KR) 10-2007-0127905

(51) Int. Cl. H04B 1/69; H04L 27/38

(52) U.S. Cl. 375/130; 375/343; 375/350; 375/E01.001

(57) ABSTRACT

A receiving apparatus of an ultra-wideband wireless system includes an analog-to-digital converter for sampling an analog signal into a digital signal, a serial-to-parallel converter for converting serial data input to the analog-to-digital converter into M:N parallel data, a matched filter bank unit for match-filtering the N parallel data, a cross-correlator bank unit for cross-correlating an output of the matched filter bank unit with a ternary code, a preamble boundary detecting unit for receiving an output signal of the cross-correlator bank unit to detect a starting boundary of a ternary code, a multi-path profile calculating unit for receiving an output signal of the cross-correlator bank unit to calculate multi-path phase and amplitude variation, a despreading unit for despreading an output of the matched-filter bank unit using a spreading code, and a data demodulating unit for receiving the despread value to determine a position and phase of a pulse. The receiving apparatus and the receiving method of the UWB wireless system are capable of achieving low power implementation by using a low system clock with a parallel structure, acquiring accurate signal and synchronization, and receiving a baseband signal without modifying the receiving apparatus according to channel change.

### TECHNICAL FIELD

The present disclosure relates to a receiving apparatus and a receiving method of an ultra-wideband (UWB) wireless system, and more particularly, to a receiving apparatus and a receiving method of a pulse-based UWB wireless system adopted by IEEE 802.15.4a, which are capable of achieving low power implementation by using a low system clock with a parallel structure, acquiring accurate signal and synchronization, and receiving a baseband signal without modifying the receiving apparatus according to channel change.

This work was supported by the IT R&D program of MIC/IITA.

[2006-S-070-02, Development of Cognitive Wireless Home Networking System]

### BACKGROUND ART

Pulse-based UWB wireless technology is attracting much attention as the promising technology because of its low power implementation and inherent distance estimation capabilities. The pulse-based UWB wireless technology was adopted as the physical layer technology of the IEEE 802.15.4a, the international standard of a low-rate location-aware Wireless Personal Area Network (WPAN), in March 2007.

As opposed to a typical wireless system using successive signals, an IEEE 802.15.4a pulse-based UWB wireless system employs a pulse with a pulse width of several nanoseconds.

FIG. 1 illustrates an IEEE 802.15.4a pulse-based UWB frame. Referring to FIG. 1, a modulation 104 is performed using a ternary code at a preamble section 100 and 101, and a burst position modulation (BPM), which is one of pulse position modulations, and a binary phase shift keying (BPSK) modulation 105 are performed at a header and payload section 102 and 103.

In addition, the IEEE 802.15.4a pulse-based UWB system uses a time-hopping scheme and a scrambling scheme in order to reduce inference effect.

Therefore, in recovering a pulse-based UWB receive (RX) signal, the pulse-based UWB wireless system must be able to use a low system clock in order to achieve low power implementation, and needs an accurate synchronization acquisition in order to demodulate a BPM+BPSK modulated signal. Furthermore, the facilitation of the system operation is achieved when the pulse-based UWB wireless system can be used in several channels (low-band or high-band) of IEEE 802.15.4a without modifying a receiving apparatus according to channel change.

The design of the receiving apparatus should be modified considering the fact that signal modulation schemes are different between a preamble section and a header and data section.

### DISCLOSURE OF INVENTION

### Technical Problem

Therefore, an object of the present invention is to provide a receiving apparatus and a receiving method of an UWB wireless system, which are capable of achieving low power implementation by using a low system clock with a parallel structure, acquiring accurate signal and synchronization, and receiving a baseband signal without modifying the receiving apparatus according to channel change.

### Technical Solution

To achieve these and other advantages and in accordance with the purpose(s) of the present invention as embodied and broadly described herein, a receiving apparatus of an UWB wireless system in accordance with an aspect of the present invention includes: a serial-to-parallel converter for converting an analog signal into a digital pulse signal, and sampling a serial data signal into N parallel data signals; a filtering means for detecting boundaries of the N parallel data signals output from the serial-to-parallel converter, and filtering the N parallel data signals; and a demodulating means for detecting multi-path phase and amplitude variation using the parallel data signals output from the filtering means, and demodulating the parallel data signals.

To achieve these and other advantages and in accordance with the purpose(s) of the present invention, a receiving apparatus of an UWB wireless system in accordance with another aspect of the present invention includes: an analog-to-digital converter for sampling an analog signal into a digital signal; a serial-to-parallel converter for converting serial data input to the analog-to-digital converter into M:N parallel data; a matched filter bank unit for match-filtering the N parallel data; a cross-correlator bank unit for cross-correlating an output of the matched filter bank unit with a ternary code; a preamble boundary detecting unit for receiving an output signal of the cross-correlator bank unit to detect a starting boundary of a ternary code; a multi-path profile calculating unit for receiving an output signal of the cross-correlator bank unit to calculate multi-path phase and amplitude variation; a despreading unit for despreading an output of the matched-filter bank unit using a spreading code; and a data de-modulating unit for receiving the despread value to determine a position and phase of a pulse.

To achieve these and other advantages and in accordance with the purpose(s) of the present invention, a receiving method of an UWB wireless system in accordance with another aspect of the present invention includes: converting a received analog signal into a digital signal; converting the converted digital signal into M:N parallel data signals; match-filtering a signal-to-noise ratio (SNR) of the converted parallel data signals; outputting data of a preamble section from the match-filtered parallel data signals using a ternary code, and outputting data of a header and payload section using a spreading code; and detecting a first peak exceeding a certain threshold value from the data of the preamble section, calculating a mean value of values following the first peak, and demodulating the data of the header and payload section.

### Advantageous Effects

A receiving apparatus and a receiving method of an UWB wireless system according to the present invention are capable of achieving low power implementation by using a low system clock with a parallel structure, acquiring accurate signal and synchronization, and receiving a baseband signal without modifying the receiving apparatus according to channel change.

### BRIEF DESCRIPTION OF THE DRAWINGS

FIG. 1 illustrates an IEEE 802.15.4a pulse-based UWB frame.

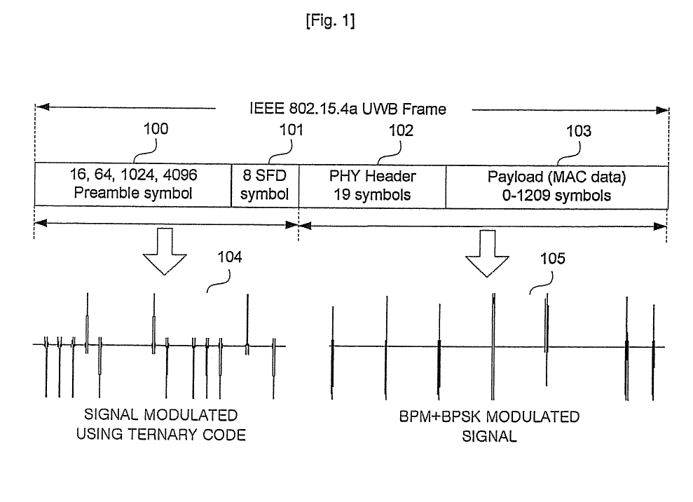

FIG. 2 is a block diagram of a receiving apparatus of an UWB wireless system according to an embodiment of the present invention.

FIG. 3 illustrates an IEEE 802.15.4a UWB channel operation.

FIG. 4 illustrates the ternary code and the output characteristics of the correlators.

FIG. 5 illustrates a channel profile obtained from the correlation result of the ternary code of the UWB packet and the received signal.

FIG. 6 is a flowchart illustrating a receiving method of an UWB wireless system according to an embodiment of the present invention.

### BEST MODE FOR CARRYING OUT THE INVENTION

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

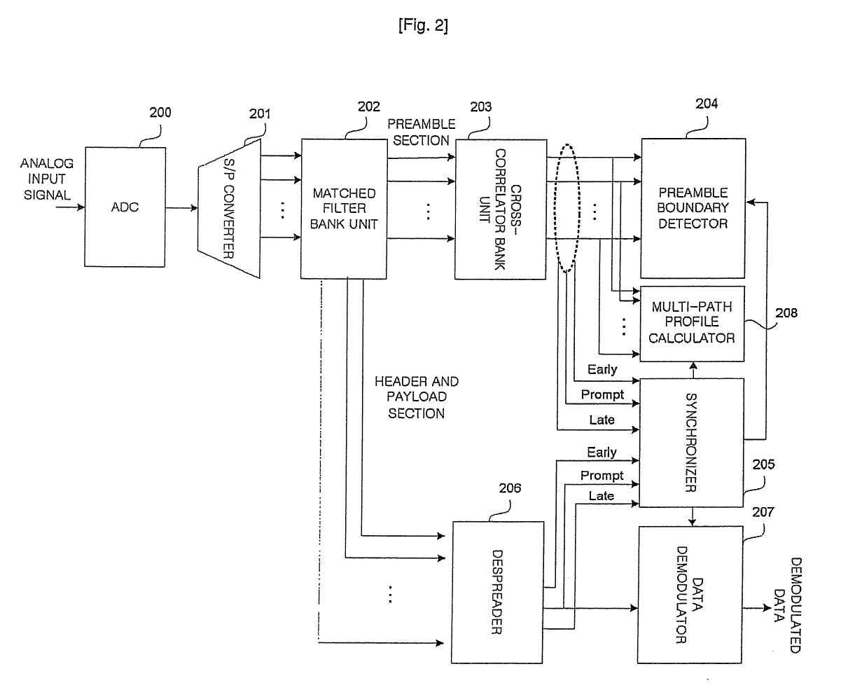

FIG. 2 is a block diagram of a receiving apparatus of an UWB wireless system according to an embodiment of the present invention. Referring to FIG. 2, the receiving apparatus of the UWB wireless system according to the embodiment of the present invention includes an analog-to-digital converter (ADC) 200, a serial-to-parallel (S/P) converter 201, a matched filter bank unit 202, a cross-correlator bank unit 203, a preamble boundary detector 204, a multi-path profile calculator 208, a de-spreader 206, a data demodulator 207, and a synchronizer 205. The ADC 200 receives an analog signal and samples the received analog signal into a digital signal. The S/P converter 201 converters serial data input to the ADC 200 into M:N parallel data. The matched filter bank unit 202 match-filters the N parallel data. The cross-correlator bank unit 203 cross-correlates the outputs of the matched filter bank unit 202 with a ternary code. The preamble boundary detector 204 receives the output signals of the cross-correlator bank 203 to detect a starting boundary of the ternary code. The multi-path profile calculator 208 receives the output signals of the cross-correlator bank unit 203 to calculate multi-path phase and amplitude variation. The despreader 206 despreads the outputs of the matched filter bank unit 203 using a spreading code. The data demodulator 207 receives the despread value to determine a position and phase of a pulse. The synchronizer 205 receives a prompt path sample, a path which is 1 sample earlier than the prompt path sample, and a path which is 1 sample later than the prompt path sample, which are output from the cross-correlator bank unit 203 or the de-spreader 206, and synchronizes a phase and timing of the signal.

M ADCs 200 (where M≧1) are provided to sample M baseband pulse-based UWB signals. Typically, the sampling is done as much as two or more times the frequency bandwidth of the UWB signal. Also, data can be recovered using an efficient algorithm, even though it does not exceed more than two times.

Since the analog signals are all converted into digital signals, any channel (low-band or high-band) whose frequency bandwidth is not changed can be used without modifying the receiving apparatus.

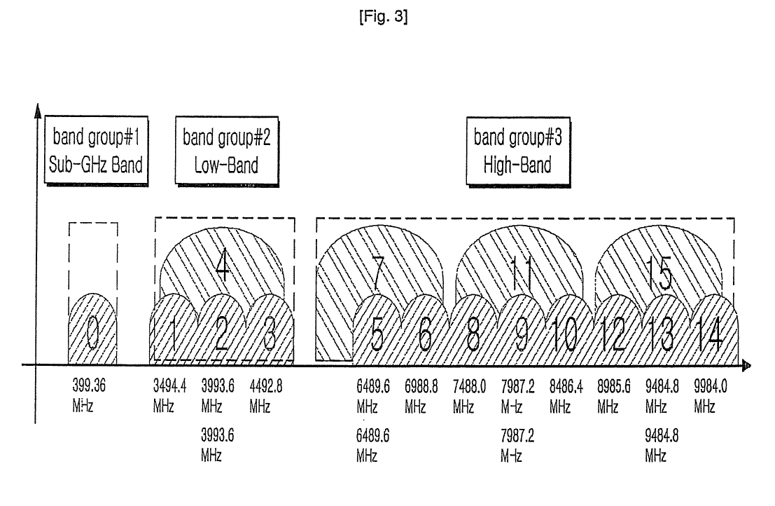

FIG. 3 illustrates an IEEE 802.15.4a UWB channel operation. Referring to FIG. 3, since all channels other than channels 4, 7, 11 and 15 have the same frequency bandwidth, the baseband receiving apparatus is not changed even when any channel is used.

The S/P converter 201 converts the serial data from the ADC 201 into the M:N parallel data and simultaneously outputs N data while the operating clock of the receiving apparatus of the UWB wireless system is reduced by N times compared to the ADC clock.

The matched filter bank unit 202 includes N matched filters and is used for maximizing a signal-to-noise ratio (SNR) of the signal. The matched filter bank unit 202 can simultaneously produce N outputs of the N matched filters. Each of the matched filters performs a filtering at a rate that is N times lower than a sampling rate of the ADC 200, but N parallel data output values of the matched filters are filtered at the sampling rate of the ADC 200. At this point, a coefficient of the matched filter is identical to that of a pulse used in a transmitting apparatus of the UWB wireless system. In the TREE 802.15.4a, a root-raised cosine (RRC) pulse is used as a reference pulse.

The cross-correlator bank unit 203 simultaneously outputs N cross-correlation values by sequentially applying the N parallel data output from the matched filter bank unit 202 to filters having a ternary code as a coefficient. That is, the cross-correlator bank unit 203 can simultaneously output N cross-correlation values because it includes N parallel cross-correlators for correlating a ternary code consisting of {1, −1, 0} with the outputs of the matched filter bank unit 202. At this point, the parallel data output values of the cross-correlators are filtered at the sampling rate of the ADC.

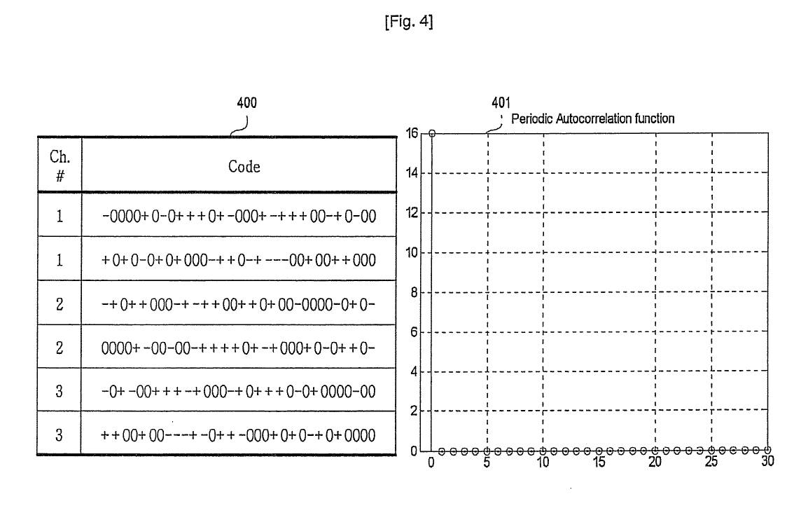

FIG. 4 illustrates the ternary code and the output characteristics of the correlators.

Referring to FIG. 4, the ternary code 400 is a ternary code set defined in the IEEE 802.15.4a. The ternary code 400 has a length of 31, fifteen zeros, and sixteen non-zeros (1 or −1). The ternary code is one frame symbol in the UWB frame. At this point, when the ternary code 400 is auto-correlated with its code, it has a peak when they coincide with each other, but has zero when they do not coincide with each other.

The preamble boundary detector 204 finds a first peak exceeding a certain threshold value among the N outputs of the cross-correlator bank unit 203, and finds the preamble boundary by detecting which one of the N paths the first peak corresponds to. At this point, when the preamble boundary is found, the number of chips constructing the preamble and the number of chips constructing the header and data section are determined. Thus, the SFD boundary, the header boundary, and the data payload boundary are found. That is, a timing synchronization is achieved.

When the preamble boundary, that is, the first peak exceeding the certain threshold value is found from the outputs of the cross-correlator bank unit 203, the following output values of the cross-correlator bank unit 203 become a multi-path profile. Thus, the multi-path profile calculator 208 calculates a mean value of the multi-path profile.

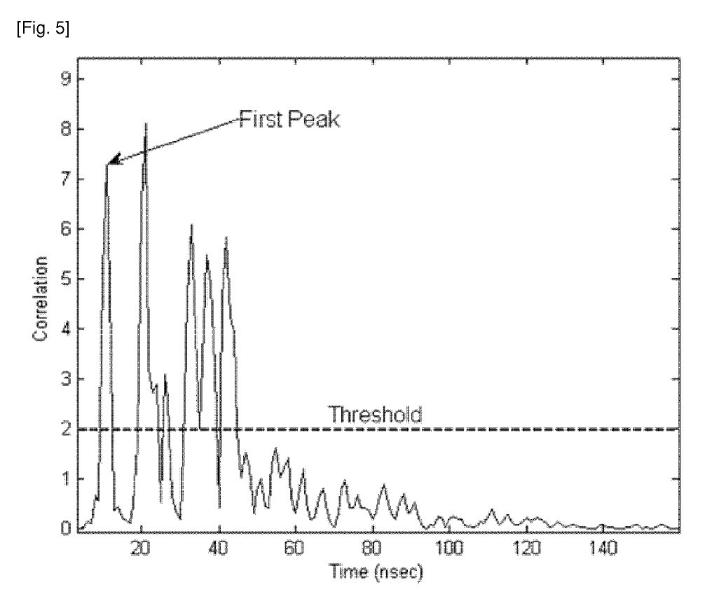

More specifically, a channel profile obtained from the correlation result of the ternary code of the UWB packet and the received signal is illustrated in FIG. 5. FIG. 5 shows the outputs of the cross-correlator bank unit 203, based on the signal received in a multi-path channel environment (IEEE 802.15.4a channel model No. 1). The first peak exceeding the threshold value represents the detection of the preamble boundary, and the following values correspond to the multi-path profile. The multi-path profile may be used in a distance estimation, which is one of main purposes of the IEEE 802.15.4a standard, and may be used in the despreader 206 for collecting multi-path energy.

The despreader 206 includes a filter for multiplying a spreading code, considering the time-hopping position. The despreader 206 is designed to have a spreading gain while it has a low power characteristic in the IEEE 802.15.4a UWB system. Thus, the despreader 206 facilitates the data detection through dispreading using the spreading code. The despreader 206 obtains a prompt sample corresponding to the peak of the pulse and despreading output values corresponding to an early sample and a late sample, and makes it possible to perform a phase and timing tracking even at the header and payload sections by applying the despreading output values to the synchronizer 205.

The synchronizer 205 includes a timing synchronizer and a phase synchronizer. The timing synchronizer receives values corresponding to the prompt path, the early path, and the late path among the output values of the cross-correlator bank unit 203 or the despreader 206, and tracks a timing error caused by a clock offset during a transmission/reception period. The phase synchronizer tracks and compensates the phase of the prompt output value.

More specifically, when the timing synchronization has been acquired at the preamble boundary detector 204, the phase may change and the timing synchronization may be distorted due to the clock offset during the transmission/reception period as time elapses, that is, the UWB frame is received. Therefore, it is necessary to track the phase and the timing synchronization.

In order to track the timing synchronization, the prompt path found by the preamble boundary detector 204, the path which is 1 symbol earlier than the prompt path, and the path which is 1 sample later than the prompt path, are applied, and the changes of their magnitudes are detected as time elapses. Then, the outputs of the cross-correlators are adjusted on a sample basis to make the prompt always become the peak of the UWB pulse.

Furthermore, since the BPSK modulation is also used, the variation of the phase must also be tracked. The phase can be compensated using the outputs of the cross-correlators. As one example, after calculating a phase of a prompt sample, it can be compensated by predicting a phase of a next prompt sample.

The data demodulator 207 demodulates the BPM+BPSK modulated signal using the output of the despreader 206. At this point, the demodulated data is applied to a channel decoder, such as a Viterbi decoder and an RS decoder, and then are post-processed.

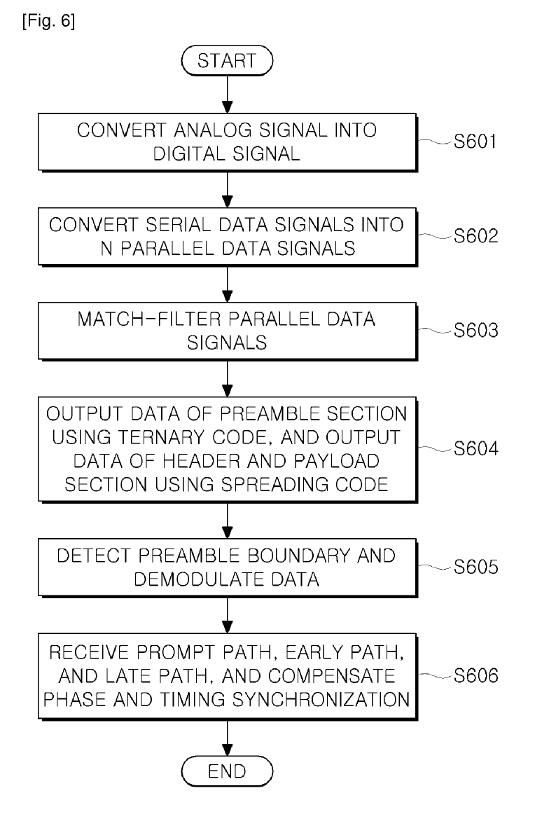

FIG. 6 is a flowchart illustrating a receiving method of an UWB wireless system according to an embodiment of the present invention.

Referring to FIG. 6, a received analog signal is converted into a digital signal in operation S601. That is, since the analog signal is converted into the digital signal, any channel (low-band or high-band) whose frequency bandwidth is not changed can be used without modifying the receiving apparatus.

In operation S602, the converted digital signal is converted into M:N parallel data signals. That is, by converting the serial data into the M:N parallel data, the operating clock of the UWB wireless system is reduced by N times compared to the clock of the ADC, and the N data are simultaneously output.

In operation S603, the SNR of the parallel data signal is match-filtered. That is, the N matched filters are used for maximizing the signal-to-noise ratio (SNR) of the parallel data signal and can simultaneously produce N outputs. Each of the matched filters performs a filtering at a rate that is N times lower than a sampling rate of the ADC, but data output values of the N parallel matched filters are filtered at the sampling rate of the ADC. At this point, a coefficient of the matched filter is identical to that of a pulse used in a transmitting apparatus of the UWB wireless system. In the IEEE 802.15.4a, a root-raised cosine (RRC) pulse is used as a reference pulse.

In operation S604, data of the preamble section are output from the match-filtered parallel data signal by using a ternary code, and data of the header and payload section are output using a spreading code.

More specifically, N cross-correlation values are simultaneously output by sequentially applying the data of the preamble section to the filters having the ternary code. That is, the N cross-correlation outputs can be simultaneously output from N parallel cross-correlators which are configured in parallel for correlating the ternary code consisting of {1, −1, 0}. At this point, the parallel data output values of the cross-correlators are filtered at the sampling rate of the ADC.

Furthermore, the data detection is facilitated by dispreading the data of the header and payload section, considering the time-hopping position. At this point, the de-spreading output value of the prompt sample corresponding to the peak of the pulse and the despreading output values of the early sample and the late sample are obtained and applied to the synchronizer 205, so that the phase and timing can be tracked even at the header and payload section.

In operation S605, the first peak exceeding the certain threshold value is detected from the data of the preamble section, and a mean value of values following the first peak is calculated. Data of the header and payload section are demodulated.

More specifically, after finding the first peak exceeding the certain threshold value among the N outputs, the preamble boundary is found by detecting which one of the N paths the first peak corresponds to. At this point, when the preamble boundary is found, the number of chips constructing the preamble and the number of chips constructing the header and data section are determined. Thus, the SFD boundary, the header boundary, and the data payload boundary can be found. Herein, when the preamble boundary is found, the following output values become a multi-path profile. Thus, a mean value of the multi-path profile is calculated. The multi-path profile can be used in the distance estimation using the calculated mean value.

In operation S606, a prompt path sample, a path which is 1 sample earlier than the prompt path sample, and a path which is 1 sample later than the prompt path sample are received from the data output of the preamble section and the data output of the header and payload section, and the phase and timing synchronizations are compensated.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

### INDUSTRIAL APPLICABILITY

A receiving apparatus and a receiving method of an UWB wireless system according to the present invention are capable of achieving low power implementation by using a low system clock with a parallel structure, acquiring accurate signal and synchronization, and receiving a baseband signal without modifying the receiving apparatus according to channel change. Therefore, the receiving apparatus and the receiving method according to the present invention can attribute to activating the development of UWB wireless systems.

1. A receiving apparatus of an ultra-wideband wireless system, comprising:
a serial-to-parallel converter for converting an analog signal into a digital pulse signal, and sampling a serial data signal into N parallel data signals;
a filtering means for detecting boundaries of the N parallel data signals output from the serial-to-parallel converter, and filtering the N parallel data signals; and
a demodulating means for detecting multi-path phase and amplitude variation using the parallel data signals output from the filtering means, and demodulating the parallel data signals.

2. The receiving apparatus of claim 1, wherein the filtering means match-filters the N parallel data signals, outputs a data signal of a preamble section using a ternary code, and outputs a data signal of a header and payload section using a spreading code.

3. The receiving apparatus of claim 1, wherein the demodulating means synchronizes a channel of the output signal.

4. The receiving apparatus of claim 1, wherein the demodulating means detects a first peak with respect to each bit stream of the parallel data signals, receives a certain number of samples from a position of the detected first peak, and calculates the multi-path phase and amplitude variation.

5. A receiving apparatus of an ultra-wideband wireless system, comprising:
an analog-to-digital converter for sampling an analog signal into a digital signal;
a serial-to-parallel converter for converting serial data input to the analog-to-digital converter into M:N parallel data;
a matched filter bank unit for match-filtering the N parallel data;
a cross-correlator bank unit for cross-correlating an output of the matched filter bank unit with a ternary code;
a preamble boundary detecting unit for receiving an output signal of the cross-correlator bank unit to detect a starting boundary of a ternary code;
a multi-path profile calculating unit for receiving an output signal of the cross-correlator bank unit to calculate multi-path phase and amplitude variation;
a despreading unit for despreading an output of the matched-filter bank unit using a spreading code; and
a data demodulating unit for receiving the despread value to determine a position and phase of a pulse.

6. The receiving apparatus of claim 5, wherein one or more analog-to-digital converters are provided to output N pulse signals.

7. The receiving apparatus of claim 6, further comprising a synchronizing unit for receiving a prompt path sample, a path which is 1 sample earlier than the prompt path sample, a path which is 1 sample later than the prompt path sample from the cross-correlator bank unit or the despreading unit, and synchronizing a phase and timing of the signal.

8. The receiving apparatus of claim 7, wherein the synchronizing unit comprises:
a timing synchronizing unit for receiving a value corresponding to the path which is 1 sample earlier than the prompt path sample, and a value corresponding to the path which is 1 sample later than the prompt path sample, among the output values of the cross-correlator bank unit or the despreading unit, and tracking a timing error caused by a clock offset during transmission/reception periods; and
a phase synchronizing unit for tracking a phase of the prompt output value and compensating a phase difference.

9. The receiving apparatus of claim 6, wherein the serial-to-parallel converter reduces a clock rate by N times by converting the serial data output from the analog-to-digital converter into M:N parallel data, and simultaneously outputs the N parallel data.

10. The receiving apparatus of claim 6, wherein the matched filter bank unit comprises N matched filters with a filter coefficient, the N matched filters perform a filtering at a rate that is N times lower than a sampling rate of the analog-to-digital converter, and N parallel data output values of the matched filters are filtered at the sampling rate of the analog-to-digital converter.

11. The receiving apparatus of claim 6, wherein the cross-correlator bank unit simultaneously outputs N cross-correlation values by sequentially applying the N parallel data output from the matched filter bank unit to a ternary code filter.

12. The receiving apparatus of claim 6, wherein the preamble boundary detecting unit detects the first peak exceeding a certain threshold value among the N parallel data input from the cross-correlator bank unit.

13. The receiving apparatus of claim 6, wherein, after the preamble boundary detecting unit detects the first peak, the multi-path profile calculating unit receives a certain number of samples from a position of the detected first peak among the outputs of the cross-correlator bank unit, and calculates multi-path phase and amplitude variation.

14. The receiving apparatus of claim 6, wherein the data demodulating unit receives an output of the despreading unit, demodulates data of 0 or 1 by determining whether the position of the pulse is located at a beginning portion of the symbol period or an end portion of the symbol period, and demodulates data of 0 or 1 by determining whether the phase of the pulse is positive (+) or negative (−).

15. A receiving method of an ultra-wideband wireless system, comprising:
converting a received analog signal into a digital signal;
converting the converted digital signal into M:N parallel data signals;
match-filtering a signal-to-noise ratio (SNR) of the converted parallel data signals;
outputting data of a preamble section from the match-filtered parallel data signals using a ternary code, and outputting data of a header and payload section using a spreading code; and
detecting a first peak exceeding a certain threshold value from the data of the preamble section, calculating a mean value of values following the first peak, and demodulating the data of the header and payload section.

16. The receiving method of claim 15, further comprising receiving a prompt path sample, a path which is 1 sample earlier than the prompt path sample, and a path which is 1 sample later than the prompt path sample from the data outputs of the preamble section and the data outputs of the header and payload section, and compensating phase and timing synchronizations.

17. The receiving method of claim 15, wherein the detected first peak exceeding the certain threshold value is used to detect a boundary of the preamble.

18. The receiving method of claim 15, wherein after detecting the first peak exceeding the certain threshold value, the data of the preamble section is used in a distance estimation using the calculated mean value in the operation of calculating the mean value of the values following the first peak.
